(19) United States
(12) Patent Application Publication
(10) Pub. No.: US 2005/0210310 A1
(43) Pub. Date: Sep. 22, 2005

(54) Method and apparatus for operating peripheral units on a bus

(75) Inventors: Mario Bez, Augsburg (DE); Michael Kartheininger, Augsburg (DE); Gerald Andersson, Kuhbach (DE)

Correspondence Address: COHEN, PONTANI, LIEBERMAN & PAVANE, Suite 1210, 551 Fifth Avenue, New York, NY, 10176, US

(73) Assignee: Fujitsu Siemens Computers GmbH, Munchen (DE)

(21) Appl. No.: 11/069,026

(22) Filed: Feb. 28, 2005

Related U.S. Application Data
(63) Continuation of application No. PCT/DE03/02847, filed on Aug. 26, 2003.

(30) Foreign Application Priority Data
Aug. 30, 2002 (DE) 102 40 086.5

(51) Int. Cl. G06F 3/00; G06F 1/04

(52) U.S. Cl. 713/600; 710/8

(57) ABSTRACT

A method and apparatus for operating peripheral units of a computer on a bus. The maximum number of peripheral units is ascertained and an optimal clock frequency, which corresponds to the number ascertained and at which the bus is operated, is determined.

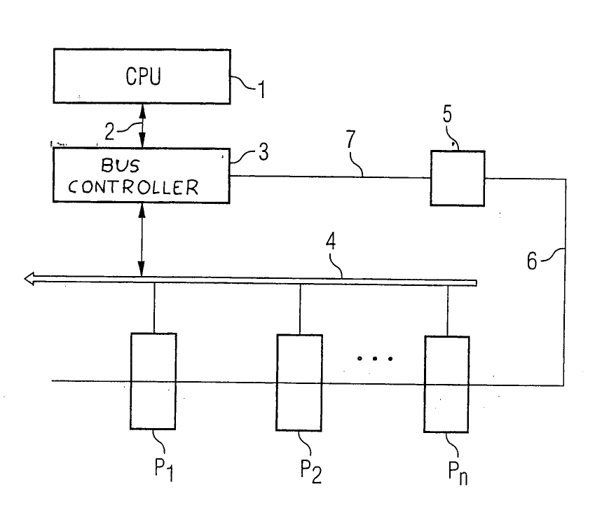

### RELATED APPLICATIONS

This is a continuation of International Application No. PCT/DE03/002847, filed on Aug. 26, 2003, which claims priority from German Patent Application No. 102 40 086.5, filed on Aug. 30, 2002 the contents of which is hereby incorporated by reference.

### FIELD OF THE INVENTION

The invention relates to a technique for operating peripheral units for a computer on a bus and, in particular, for operating the bus at the optimal clock frequency.

### BACKGROUND OF THE INVENTION

In personal computers and similar computer systems, for example servers, use is generally made of a system board or so-called “motherboard”, on which the microprocessor(s), also called the “CPU(s)”, is/are accommodated together with the main memory, called “RAM”, the read-only memory, called “ROM”, peripheral units and other important computer components. The CPU is generally connected to the peripheral units (I/O subsystem) on the system board, that is to say, for example, to the input/output controllers etc., using a bidirectional bus that has data, address, control and supply lines. The PCI (periphery component interconnect) bus, for example, is in widespread use as the bus system. A plurality of bus slots of the system board which extend parallel to one another and into which the expansion cards for functionally expanding the computer system can be inserted are generally provided on the bus. The number of expansion cards and associated functions is continuing to rise. The PCI bus is operated at a clock frequency of up to 66 megahertz as standard and, owing to a data bus Width of 32 or 64 bits, may transmit up to 132 or 266 MB per second. Attempts have been made, in the meantime, to operate the expansion cards at a higher clock rate. Accordingly, the PCI-X bus was developed and specified, which bus, at the moment, operates at a clock frequency of up to 133 (66, 100 or 133) megahertz and enables corresponding data transfer rates of up to 1 GB per second. The maximum possible bus clock frequency principally depends on the number of connected bus subscribers and on the length and arrangement of the electrical connections between the subscribers. The maximum possible bus frequency (corresponds to the maximum possible data throughput) that still ensures error-free data interchange tends to become lower the longer the bus is and the more bus subscribers are connected. Since the PCI/PCI-X bus can therefore be operated at the high clock frequency only with a restricted number of expansion cards, a change has been made, in the meantime, to operating a plurality of PCI/PCI-X bus arrangements (also called bus segments) alongside one another (depending on the capability for expansion) in a PC or server in order to achieve high data throughputs. This means that a plurality of PCI-X bus segments and/or one or more standard PCI bus segments are set up. In order to connect a PCI/PCI-X bus to the CPU bus (host bus), use is usually made of a bus controller that is referred to as a “(host to) PCI/PCI-X bridge” and connects the PCI bus to the so-called “host bus”, to which the CPU is connected. In systems of this type, the PCI/PCI-X bridges, also known as bus controllers, are therefore multiply present, namely once for each PCI bus segment. In practice, two logical bridges are sometimes combined in one physical chip. These bridges are expensive components and increase the fabrication costs of computer systems of this type.

### SUMMARY OF THE INVENTION

One object of the invention is to provide an improved method for operating peripheral devices on a bus and for providing a corresponding apparatus.

Another object of the present invention is to provide a greater flexibility as regards the type and number of peripheral devices which can be attached, to do so in a relatively simplified manner and, at the same time, increasing the data throughout.

These and other objects are attained in accordance with one aspect of the present invention directed to a method for operating a number of peripheral units on a bus, comprising ascertaining the number of peripheral units, determining an optimal clock frequency that corresponds to the number of peripheral units ascertained and operating the bus at such optimal clock frequency.

Another aspect of the present invention is directed to a computerized apparatus having a bus to which a plurality of peripheral units are coupled. A bus controller controls the bus and a determination logic unit ascertains the number of peripheral units which are coupled to the bus. The determination logic unit determines an optimal bus clock frequency for the ascertained number of peripheral units, and forwards that optimal clock frequency to the bus controller.

In one embodiment the current configuration of peripherals is determined automatically, that is to say the number of peripheral devices that are connected to the respective bus segment at present. As a result, it is possible to ascertain the consequently respective optimal maximum possible bus clock frequency. A bus segment with little expansion can thus be operated with a bus clock of 133 MHz, while the clock rate of segments with greater or full expansion is automatically reduced (100 or 66 MHz), if necessary, in order to ensure reliable data interchange on the bus.

In contrast thereto, that maximum possible clock frequency which still guarantees reliable operation in the case of a “worst case configuration” (generally full expansion) has hitherto been fixedly set. In practice, however, only partial expansion of the I/O subsystem is, for the most part, required. However, a partially expanded bus segment could not use the now theoretically possible higher bus clock frequency since the frequency was matched to the worst case and was fixedly set.

In order to keep the variety of frequencies within limits, three possible clock frequencies, namely 66, 100 and 133 MHz, were defined for the known PCI-X buses specification. Each bus subscriber must operate in a manner that is compatible with the lower frequencies and must even support the standard PCI 33 MHz mode in an emergency. The entire bus is allowed to, and can of course, run, at most, only in the mode supported by the slowest subscriber on the bus. This in turn means that the above frequency optimization can be achieved only when the slowest subscriber on the bus segment also supports this frequency. Detection of the capabilities of the plug-in cards themselves is likewise effected automatically and limits the bus frequency if need be.

There are therefore two components which limit the clock frequency: on the one hand, the system design with the respective number of bus subscribers and, on the other hand, each individual bus subscriber itself owing to the maximum frequency that it itself supports. Two PCI-X frequency classes, 133 MHz and 66 MHz, are specified for the bus subscribers. 100 MHz operation was established as an intermediate step in order to avoid having to reduce the clock rate—necessitated by the system design—from 133 MHz to 66 MHz directly. In order to be able to realize 100 or 133 MHz, all of the bus subscribers must therefore support the so-called 133 MHz PCI-X mode.

The maximum clock frequency is therefore determined from the highest supported frequency of the “slowest” bus subscriber (this is a requirement of the PCI-X specification) and the highest possible frequency of the bus segment in a manner dependent on the instantaneous expansion level (this is part of the invention). Given a corresponding bus design, all conceivable expansions are optimally supported.

### BRIEF DESCRIPTION OF THE SINGLE DRAWING

An exemplary embodiment of a bus arrangement according to the invention is schematically illustrated in the FIGURE.

### BRIEF DESCRIPTION OF THE SINGLE DRAWING

In the FIGURE, a CPU 1 is connected, via a so-called “host bus” 2 having a bus controller 3, to a bus 4, which is, for example, a “PCI-X bus”. Peripheral units P1 to PN are connected to this bus 4 by means of “slots” (not illustrated). A determination logic unit 5 uses a corresponding connection 6 to now determine how many peripheral units are connected to the bus 4, that is to say how many of the so-called “slots” are occupied. This determination is made from a signal generated by the PCI-X bus subsystem for each occupied slot. This is a well known feature of the PCI-X bus. The unit 5 uses the ascertained number of peripherals to determine an optimal bus clock frequency and communicates the latter to the bus controller 3 via a connection line 7. It is thus possible for the bus controller 3 to operate the bus 4 at the optimal bus clock frequency. In addition, each PCI I/O subsystem, which can support more than 33 MHz in a manner governed by the system, contains a logic unit (not shown), which, similarly to unit 5, ascertains the maximum possible clock frequency of the individual cards (requirement of the PCI/PCI-X specification, see above). In a well known manner, a code is available for each peripheral to indicate the clock frequency specified for it and, in particular, its maximum possible clock frequency. This maximum common clock frequency is the lowest clock frequency of the respective maximum clock frequency of the individual bus subscriber.

In all systems in which the invention is used, it is expedient to process all of the parameters affecting the bus clock frequency in a common logic unit, in this case the unit 5. For example, unit 5 can include a table of all possible combinations necessary to ascertain the optimal clock frequency. It is thus possible for the unit 5 to ascertain the optimal bus clock frequency and to communicate this value (conditioned in accordance with the signaling) to the bus controller 3 as the optimal bus clock frequency that is actually to be set.

In addition to this hardware solution, which was explained with reference to the FIGURE, a software-based solution is also conceivable. All relevant information, including the actual frequency, is available at software readable I/O ports of the chip set. The so-called “BIOS” can be used to ascertain both the number of peripheral devices and the properties thereof. It is thus possible for the CPU to use the data which can be ascertained using “BIOS” to supply the bus controller 3 with corresponding information, so that the bus controller 3, both in accordance with the number of peripheral units and in accordance with the maximum common clock frequency, can ascertain the actual optimal bus clock frequency and, during booting of the system, controls the bus in a corresponding manner.

The following configuration, for example, is possible in accordance with the present technical realizability. The bus 4 is a PCI-X bus, which can be operated, as the optimal clock frequency, at a bus clock frequency of 133 megahertz when one slot is occupied, can be operated at 100 megahertz when two slots are occupied, can also be operated at 100 megahertz when three slots are occupied and can be operated at 66 megahertz when four slots are occupied, provided that the cards respectively support at least this frequency.

Standard systems must now fixedly set 66 MHz in accordance with the worst case (4 cards inserted). Even if only one card is inserted, it may then be operated only at 66 MHz. The system therefore exclusively affords 66 MHz slots. In order to circumvent this problem, two PCI-X segments, one having one slot and one having three slots, for example, are now realized, for example. In this way, the system affords the same capability for expansion (namely 4 plug-in cards) and can also support at least one slot at 133 MHz. However, this requires the use of a second, expensive PCI-X bridge.

The solution described by the invention therefore results in the following advantages.

The complicated design of two bus arrangements is avoided in this manner and it is not necessary to use a second, expensive bridge. The arrangement described and the method described always ensure that, irrespective of whether cards for the conventional PCI system or for the PCI-X system are used, the appropriate bus clock frequency that is needed for reliable operation is always set. If too many fast cards which cannot be operated together at the high clock frequency in accordance with the PCI-X standard are used, an appropriate lower clock frequency is set. In the case of systems which are capable of relatively great expansion, up to 16 slots are entirely common. A very large number of configurations are then conceivable. The invention generally makes it possible to halve the number of PCI bus segments and, at the same time, allows a comparable degree of flexibility and maximum performance.

The basic principle of the system described with reference to the PCI bus and PCI-X bus can also be applied to other bus systems and is not tied to the PCI system. However, further developments which in turn will operate at higher data transfer rates are already planned for today's PCI-X bus.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A method for operating a number of peripheral units on a bus, comprising:
ascertaining the number of peripheral units;
determining an optimal clock frequency that corresponds to the number of peripheral units ascertained; and
operating the bus at said optimal clock frequency.

2. The method as claimed in claim 1, in which the maximum clock frequency at which all of the peripheral units can be operated is determined and the bus is operated at this maximum clock frequency determined.

3. A computerized apparatus having a bus (4) to which a plurality of peripheral units (P1, . . . , Pn) are coupled, comprising:
a bus controller (3) to control the bus; and
a determination logic unit (5) to ascertain the number of peripheral units which are coupled to the bus (4), to determine an optimal bus clock frequency for the ascertained number of peripheral units, and to forward said optimal clock frequency to the bus controller (3).

4. The arrangement as claimed in claim 3,
wherein
the determination logic unit (5) determines the maximum common clock frequency for all of the peripheral units and forwards it to the bus controller (3).

5. The arrangement as claimed in claim 4,
wherein
the determination logic unit (5) ascertains the optimal bus clock frequency and the maximum common clock frequency, and operates the bus (4) at whichever clock frequency is lower.

6. The arrangement as claimed in claim 4,
wherein
the determination logic unit (5) ascertains the optimal bus clock frequency and the maximum common clock frequency and communicates whichever clock frequency is lower to the bus controller (3) as the optimal bus clock frequency.

7. A computerized apparatus having a bus (4) to which a plurality of peripheral units (P1, . . . , Pn) are coupled, comprising:
a bus controller (3) including means for controlling the bus; and
a determination logic means for ascertaining the number of peripheral units which are coupled to the bus (4), determining an optimal bus clock frequency for the ascertained number of peripheral units, and forwarding said optimal clock frequency to the bus controller (3).
